(19) United States
(12) Patent Application Publication
(10) Pub. No.: US 2002/0141847 A1
(43) Pub. Date: Oct. 3, 2002

(54) Screw having external driving recesses

(76) Inventors: Sae Young Oh, Ellicott City, MD (US); Gene Serk Oh, Ellicott City, MD (US)

Correspondence Address: JACOBSON, PRICE, HOLMAN & TERN, PROFESSIONAL LIMITED LIABILTY COMPANY, THE JENIFER BUILDING, 400 SEVENTH STREET, N.W., WASHINGTON, DC, 20004, US

(21) Appl. No.: 09/824,223

(22) Filed: Apr. 3, 2001

(51) Int. Cl. F16B 23/00

(52) U.S. Cl. 411/402

(57) ABSTRACT

A screw nail having a nail head with rounded peripheral portions alternatingly arranged with vertically cut external recesses. Gyration power for insertion or removal of the screw nail from a target surface is transmitted to the screw through the recesses using a suitable driving device. A groove in the flat upper surface of the nail head is of auxiliary use for transmitting rotational force, but is of insufficient depth to drive the screw nail into a surface independently of the recesses. By driving the screw nail using the external grooves, the requirement for alignment with the driving device is reduced and, because the nail heads can be thinner, the screw nails may be more inexpensively produced.

### BACKGROUND OF THE INVENTION

1. Field of the Invention

The invention is related to the field of threaded fasteners and, more particularly, to screws or screw nails, which are used in various building or carpentry materials including sheet metals, plastics, woods, plywoods, dry woods, etc.

2. Description of Related Arts

As a race, human beings have continually pursued a higher quality of life. Modern wooden products have solicited a larger demand for lumber around the world. Lumber is used for such commodities as furniture, buildings, railroad tracks, electric line poles, and pencils. The search for superior living conditions, however, is a preface to the destruction of forestry, worldwide. The necessity for lumber, as well as the need for cleared acreage for human rural and urban zones, is a cause of this clearing of flora. Modern science has shown that this desire for further human population and development has become a global crisis, reducing timberland on a terrestrial scale. This has been well noted, as an effort to reduce the consumption of forestry has been put forth through natural reservations, as well as substitute materials for wood construction.

Threaded fasteners such as screws and screw nails are commonly used on various commercial products, industrial materials and domestic articles. Threaded fasteners are better capable of maintaining a grip on multiple pieces of given materials compared to regular nails, are less strenuous to apply than other methods such as welding and gluing, and also allow the given materials to be disassembled with far less risk of damage. These fasteners are also easier and quicker to implement into the assembly of products, and allow for a reliable grasp on materials. The overall result is more economical expenditure in manufacturing costs, as well as efficiency in the production of goods.

The threaded fastener retains a spiraled structure and, according to the prior art, the interaction and direct contact between a driving device and the head of a screw nail is the standard by which screw nails are driven into materials. Clockwise revolutions allow the fastener to advance into the target material, and counter-clockwise revolutions allow the screw nail to retract from the material. It is, however, necessary to rotate the threaded fastener in order to make it functional, whether to make it progress or withdraw from a material.

In order to utilize these screws, which have variously shaped slots, e.g. crosses, squares, hexagons, etc., it is necessary to find the appropriate driver and screw bit for manually or electrically powered screw driving. Subsequently, the driving tool must be positioned with the screw bit in a manner such that the driver, the screw, and the material are all in essentially linear alignment. The rotating force of the driver transmits energy from the driver to the spinning axis of the screw nail. This transfer of kinetic energy must be engaged through direct physical contact between the driver and the screw nail. These factors must remain constant in order for the screw to be successfully driven. During the process of driving, if the nail comes out of alignment with either the driver or the target material, or if the amount of force upon the screw nail from the driver is insufficient, applied energy will not be effectively transferred to the nail. In either event, the nail will not enter the target in a desired manner, and the improperly applied force may distort the screw nail head and/or grind the screwdriver tip.

In the event that the nail does become deformed, much time and effort is required in order to remove the screw nail from the targeted material. This is due to the fact that if a screw nail is distorted, it will no longer be capable of being rotated to proceed and/or withdraw from the surface. Aside from damaging the driver and/or wasting the useless and deformed screw nail, there is a probable chance that the damaged screw nail may disfigure the target material.

There is also a present danger when driving a screw nail into a material that is not adjacent to the body of the person who is working with driving tools, such as when the person is working on a ladder. Under these circumstances, aligning the screwdriver, screw nail, and the desired target material can prove to be a daunting task. Driving under these conditions is likely to result in failed screw driving, in addition to exposing the person to unnecessary danger.

Furthermore, when driving into a material with a slick surface, such as metal, fiberglass, or Formica, it is very difficult to drive into the target properly, as constant alignment and direct contact must be kept during the driving process.

Ordinary screws, or screw nails, can be classified into two categories. The first category includes screw nails used on such materials as wood, plywood, and dry walls. This type of screw nail has a flat head and is shaped with a neck that can burrow into the target surface. Horizontally, the heads of these screw nails are thin and have narrow, but deep, groove slots. These groove slots, which are often straight or cross-shaped, allow the driver to apply gyration energy upon the axis of the nail. Such slotted grooves must be of sufficient depth within the head, such that the transmission of energy is adequate to allow entry into the target material.

The second category of screws is generally used for metals and plastics. This type has a flat neck and a round, curved head, which is not used for burrowing completely into a surface. The grooves or slots within this category of screws are also used for the transmission of energy from the driver to the nail and require a minimal depth in order for the transmission of power from the driver to be sufficient to drive into the target material. Therefore, the thickness of the screw heads is generally large to allow for deep grooves. Yet, the general thickness used within screw nail heads is of no further use once the nail has been driven into a surface.

A prior invention used the idea of keeping grasp of a screw nail during the driving process. Inevitably, however, this device has to release the screw at some point before the entire process is completed, due to the nature of the nail itself. In other words, after driving the nail to a certain point within the surface, manual driving is required to complete the process. Therefore, mechanical ramifications prevented perfection of this device.

Accordingly, a need exists for a device that will transmit power from the exterior of a screw nail, not only allowing a more powerful gyration force, but also allowing the transmission of power even after the nail is released from a device's grasp in order to complete the driving process.

There is also a need for another system by which the task of driving a screw nail into a material may be accomplished with reduced alignment requirements and which is safer to use in particular situations.

### SUMMARY OF THE INVENTION

In view of the foregoing reasons, it is an object of the present invention to provide a screw nail that does not rely upon a central slot as the primary means of transferring rotational force for insertion or removal.

Another object of the present invention is a screw or screw nail having external recesses upon the outer ring of the nail's head for engaging with a driving device, the screw nail being rotated using these external recesses to provide more effective gyration power.

A further object of the invention is a screw nail that implements shallow grooves onto the nail head, improving the general design of the screw and, by reducing the screw head's thickness, allowing for more efficient production of screw nails as fewer raw materials are used for a single nail.

A still further object of the invention is a screw nail that may be inserted and removed from a target material with reduced alignment requirements as between the nail and the driving device.

Another object of the present invention is an improved screw nail that greatly reduces the risk of creating distorted nails, and which also nullifies the risk of damaging the target surface through the removal of distorted nails.

Still a further object of the present invention is a screw nail that allows the driving of high and inaccessible target surfaces to be completed with the utilization of extension rods for the driving device, allowing for safer operation.

It is also an object of the invention to provide a screw nail that is not complex in structure and which can be manufactured efficiently and at low cost.

According to the present invention, a screw nail is provided having recesses upon the outer ring of the nail's head. Instead of relying upon a center groove to impart rotational energy to the screw, the outer recesses provide the point of contact between the driving device and the screw, providing greater efficiency. The screw nail is permitted to slide up and down within the shaft of the cylindrical component of the driving device which has concurrently shaped/sized ridges. The nail is only permitted, however, to rotate in conjunction with the cylinder component. This is accomplished by locking the nail at a fixed axis through use of the nail's recesses and corresponding notches within the cylinder.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1a is a top view of a screw nail, showing the recesses within the outer ring of the nail head, in accordance with the present invention;

FIG. 1b is a side view of the screw nail of FIG. 1a, showing a comparison between two different groove depths within nail designs of the prior art and the present invention;

FIG. 1c is a perspective three-dimensional view of the screw nail of FIG. 1a, showing the recesses within the outer ring of the nail head, as well as a shallow cross-shaped groove within the nail head;

FIG. 2a is a top view of an alternative embodiment of a screw nail according to the present invention, showing the recesses within the outer ring of the nail head;

FIG. 2b is a side view of the screw nail of FIG. 2a, showing a comparison of heights between the prior art screw nail design, shown by dotted lines, and the new design according to the present invention;

FIG. 2c is a three-dimensional perspective view of the screw nail of FIG. 2a, showing the shallow groove within the top of the nail head, and also the flat head, of the new design;

FIG. 3 is a top view of another embodiment of a screw nail with a square groove upon the nail head, in accordance with the present invention; and

FIG. 4 is a top view of yet another embodiment of a screw nail with different contoured design of recesses on the outer ring of the nail head, as well as a hexagonal groove within the nail head, in accordance with the present invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

This invention highlights the screw nail's spiral structure's self-functionality, i.e., its ability to proceed and withdraw independently.

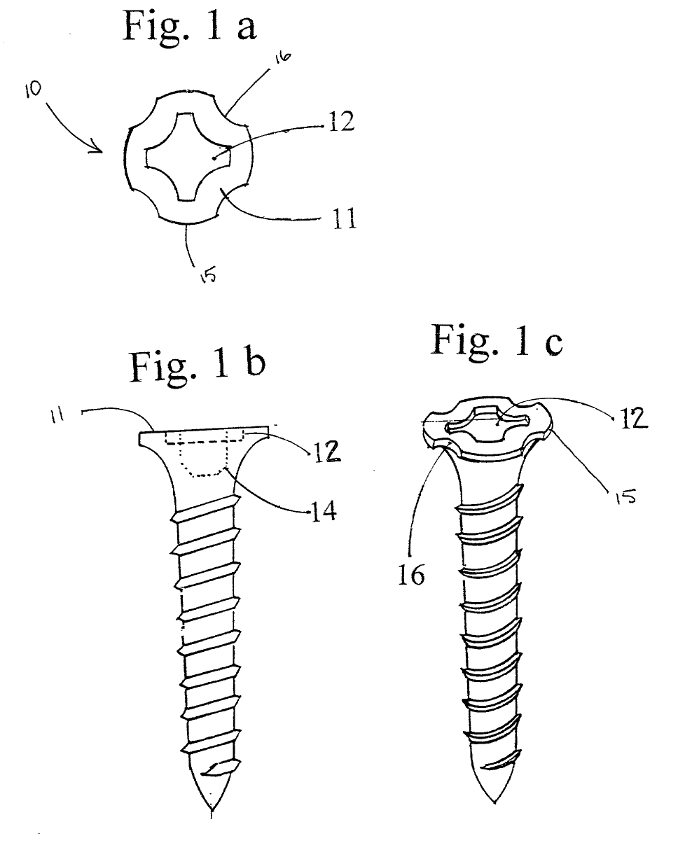

As shown in FIGS. 1a, 1b and 1c, the present invention is directed to a screw nail having a nail head, generally designated by the reference numeral 10. The nail head 10 has a substantially flat upper surface 11, a generally cross-shaped groove 12 inset in the upper surface 11, rounded peripheral portions 15 and vertically cut external recesses 16.

As shown in FIG. 1b, the depth of the groove 12 is very shallow in comparison with the depth of a groove, depicted by the dotted line 14, that would be present in a conventional screw nail. In further contrast to a conventional screw, the groove 12 is auxiliary to the functionality of the screw nail of the present invention, the screw nail of the present invention being driven into target materials through reliance on the recesses 16. Because the groove 12 is auxiliary only, a deep groove in the head 10 is not required.

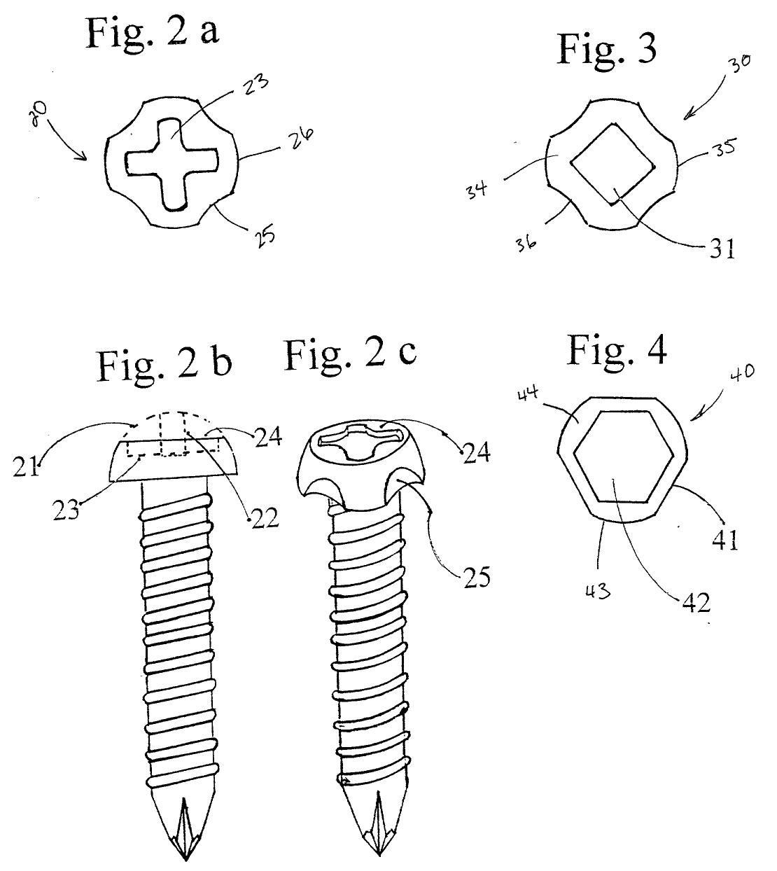

An alternative embodiment according to the present invention is shown in FIGS. 2a, 2b and 2c. As shown, the screw nail has a nail head, generally designated by the reference numeral 20. The nail head 20 has a substantially flat upper surface 24, a generally cross-shaped groove 23 inset in the upper surface 24, rounded peripheral portions 26 and vertically cut external recesses 25.

As shown in FIG. 2b, the depth of the groove 23 is very shallow in comparison with the depth of a groove, depicted by the dotted line 22, that would be present in a conventional screw nail. The rounded top of a conventional screw head is depicted by dotted line 21. As with the embodiment shown in FIGS. 1a-1c, the groove 23 is auxiliary to the functionality of the screw nail of the embodiment of FIGS. 2a-2c, the screw nail of the present invention being driven into target materials through reliance on the recesses 25. Because the groove 23 is auxiliary only, a deep groove in the head 20 is not required. This not only allows the screw nail head to be thinner in design, but also represents a more efficient use of raw materials. The lower profile head also improves the design and utilization of screw nails within surfaces, e.g. the discontinuation of round screw nail heads protruding from target surfaces.

Another alternative embodiment according to the present invention is shown in FIG. 3. As shown, the screw nail has a nail head, generally designated by the reference numeral 30. The nail head 30 has a substantially flat upper surface 34, a generally square-shaped groove 31 inset in the upper surface 34, rounded peripheral portions 35 and vertically cut external recesses 36.

A further alternative embodiment according to the present invention is shown in FIG. 4. As shown, the screw nail has a nail head, generally designated by the reference numeral 40. The nail head 40 has a substantially flat upper surface 44, a generally hexagonally-shaped groove 42 inset in the upper surface 44, rounded peripheral portions 43 and vertically cut external recesses 41. The embodiment in FIG. 4 includes only three recesses 41 within the head 40, but a greater or fewer number of recesses may be used without departing from the scope of the present invention. Similarly, the groove in the head may have other shapes, such as octagonal, pentagonal, etc., with each such shape most naturally lending itself to different numbers of recesses. Thus, when designing the screw nail heads, the outer recesses and the inner grooves can be designed correspondingly, as shown in the figures.

According to the present invention, the outer recesses in the nail head provide the point of contact between a suitable driving device and the screw. These inventive screw nails may be used with a driving device such as that disclosed in U.S. Pat. No. 6,155,145, which is hereby incorporated by reference in its entirety. Using a screw driving apparatus such as that shown therein, the screw nail is permitted to slide up and down within the shaft of the cylindrical component of the driving device which has concurrently shaped/sized ridges. In the preferred embodiment, the nail is only permitted to rotate in conjunction with the cylinder component. This is accomplished by locking the nail at a fixed axis by use of the nail's recesses and corresponding notches within the cylinder. Alternative driving devices designed to accommodate the inventive screw nails may also be used.

The foregoing descriptions and drawings should be considered as illustrative only of the principles of the invention. The invention may be configured in other shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

We claim:

1. A screw nail having a nail head with rounded peripheral portions and vertically cut external recesses, said screw nail being rotated through force applied to said recesses.

2. The screw nail as set forth in claim 1, said nail head having a flat upper surface and including a groove therein, said groove providing a secondary means for transmitting power for driving the screw nail into a surface.

3. The screw nail as set forth in claim 2, wherein the groove is of insufficient depth to be used for driving the screw nail into the surface independently of the force applied to said recesses.

4. The screw nail as set forth in claim 1, said rounded peripheral portions and said external recesses alternating around a periphery of said nail head.

5. The screw nail as set forth in claim 2, wherein the groove is a polygon having a given number of sides, with a number of recesses being equal to said given number of sides.

6. The screw nail as set forth in claim 5, wherein the groove is a square having four sides, with the number of recesses also being four.

7. The screw nail as set forth in claim 2, wherein the groove is a polygon having a given number of sides, with a number of recesses being half said given number of sides.

8. The screw nail as set forth in claim 7, wherein the groove is a hexagon having six sides, with the number of recesses being three.

9. The screw nail as set forth in claim 2, wherein the groove is cross-shaped, and a number of recesses and rounded peripheral portions is four, respectively.
